(19) United States
(12) Patent Application Publication
(10) Pub. No.: US 2019/0249611 A1
(43) Pub. Date: Aug. 15, 2019

(54) COMPRESSOR

(71) Applicant: BMTS Technology GmbH & Co. KG, Stuttgart (DE)

(72) Inventors: Simon Henzler, Frickenhausen (DE); Hartmut Weiss, Stuttgart (DE)

(21) Appl. No.: 16/270,595

(22) Filed: Feb. 8, 2019

(30) Foreign Application Priority Data
Feb. 9, 2018 (DE) 102018202066.3

(51) Int. Cl. F02D 41/00; F04D 27/00; F04D 17/10; F01D 17/16

(52) U.S. Cl. CPC F02D 41/0007; F01D 17/165; F04D 17/10; F04D 27/003

(57) ABSTRACT

The present disclosure relates to a compressor for compressing charge air for a combustion engine. The compressor comprises charge air inlet for the through-flow of charge air in axial direction, in which an adjustment device for adjusting a diameter of the charge air inlet is fixedly arranged. The adjustment device comprises a ring-shaped radially arranged guidance arrangement and aperture elements movably mounted in the guidance arrangement, wherein the aperture elements can be adjusted at right angles to the axial direction by the guidance arrangement in at least two closed positions. With this arrangement the diameter of the charge air inlet varies in the respective closed positions. The aperture elements are arranged in a common radial aperture plane and are supported against each other in the respective closed positions in the circumferential direction.

### CROSS-REFERENCE TO RELATED APPLICATION

This application claims priority to German Patent Application No. DE 10 2018 202 066.3 filed on Feb. 9, 2018, the contents of which are hereby incorporated by reference in its entirety.

### TECHNICAL FIELD

The invention relates to a compressor for compressing charge air for a combustion engine according to the preamble of claim 1. The invention further relates to an exhaust gas turbocharger with a turbine and with the compressor.

Compressors are already known from the state of the art and are used for compressing charge air in a combustion engine. The compressor comprises an inlet channel through which the charge air flows. Compressor performance curves are in the main determined by the geometry of the compressor. The geometry of the compressor and the inlet channel are usually consistent and as the result, the surge and choke lines in the compressor are predefined. Due to the consistent geometry of the compressor the working range of the compressor is thus limited.

Various solutions are known from the state of the art for moving or expanding the surge and choke lines. These propose to adapt the diameter of the inlet channel in the compressor. In particular moving the surge line towards smaller mass flows has a positive effect on the LET behaviour (low-end torque behaviour) of the combustion engine in a motor vehicle, as a result of which the response behaviour of the engine can be improved and also fuel consumption can be reduced.

### BACKGROUND

The JP 5 223 642 B2 and EP 3 043 045 A2 for example disclose an adjustment device for adapting the diameter of the inlet channel, the device being rotatably arranged in the inlet channel and functioning like a valve. When the adjustment device is open, the diameter of the inlet channel is not reduced, whilst with the adjustment device closed the diameter of the inlet channel is reduced. It is disadvantageous that these adjustment devices only comprise two settable states. Furthermore the open adjustment devices can obstruct the flow of the charge air through the inlet channel. In EP 3 043 045 A2 an alternative solution is additionally proposed, in which a number of segments of the adjustment device in the inlet channel are radially adjustable. However, the individual segments can have a negative influence on the airflow in the inlet channel and can lead to undesirable vibrations and sound emissions in the compressor if the adjustment device is not fully opened or closed.

The talk “turbocharger compressor with variable inlet for realising highly efficient drive concepts” by Continental Automotive GmbH at the 10^{th} MTZ symposium has disclosed a further solution which proposes a further adjustment device with three closure elements which are movable relative to each other. The movable closure elements can be pushed on top of each other in circumferential direction in order to, in this way, adapt the diameter of the inlet channel. Disadvantageously the closure elements are in contact with each other so that different dead volumes are produced in circumferential direction of the inlet channel. This can lead to turbulences in the airflow, which puts an unnecessary stress on the compressor wheel and leads to undesirable vibrations and sound emissions in the compressor.

DE 10 2010 026 176 B4, DE 10 2011 121 996 A1, DE 2013 003 418 A1 and U.S. Pat. No. 9,683,484 B2 circumvent these disadvantages, in that an internal surface of the inlet channel is adapted by an adjustment device, respectively. The adjustment devices consist of a number of strips which, being arranged axially adjacent to each other, form the internal surface of the inlet channel. The setting angle of the strips can be changed relative to the inlet channel so that the diameter of the inlet channel can be adapted. Disadvantageously these adjustment devices are very complex from a manufacturing point of view and thus cost-intensive. Further these solutions require additional installation space which often is not available.

Therefore it is the requirement of the invention to propose an improved or at least alternative embodiment for a generic compressor, with which in particular the described disadvantages are overcome.

According to the invention this requirement is met by the subject of the independent claims. Advantageous embodiments are the subject of the dependent claims.

A generic compressor is suitable for compressing charge air for a combustion engine and comprises a charge air inlet through which charge air can flow in axial direction. An adjustment device is fixedly arranged in the charge air inlet for adjusting the diameter of the same. The adjustment device comprises a ring-shaped guidance arrangement arranged radially at the charge air inlet and a number of aperture elements movably mounted in the guidance arrangement. The aperture elements can be adjusted at right angles to the axial direction by the guidance arrangement in at least two closed positions, wherein the diameter of the charge air inlet varies in the respective closed positions. According to the invention the aperture elements are tightly fitted—in other words arranged in a common radial aperture plane and are supported against—each other in the at least two closed positions.

In the respective closed positions the diameter of the charge air inlet is radially reduced so that the charge air flow/the flow-through cross-section is reduced. In this way the surge line can be moved towards smaller mass flows thereby improving the response behaviour of the engine and reducing fuel consumption. The adjustment device according to the invention may, in principle, comprise an infinite number of closed positions occurring between a maximally closed position and a minimally closed position. This means that the diameter is at its minimum in the maximally closed position and at its maximum in the minimally closed position. Due to the guidance arrangement the aperture elements can be moved perpendicularly to the axial direction and thus within the aperture plane. Furthermore the respective aperture elements are, according to the invention, supported against each other in circumferential direction and arranged in a common radial aperture plane, i.e. in an aperture plane at right angles to the axial direction. As a result it is possible, in particular, to avoid turbulences in the airflow and therefore also undesirable vibrations and sound emissions in the compressor as well as a non-stationary load on the blades of a compressor wheel.

With an advantageous further development of the adjustment device according to the invention it is provided that the aperture elements, in their respective closed positions, form a radially essentially closed, ring-shaped aperture surface with a central flow orifice for the through-flow of the charge air. The essentially closed ring-shaped aperture surface prevents the charge air from flowing through between the individual aperture elements, so that turbulences in the airflow can be reduced. The aim is to obtain a fully closed or at least substantially closed ring-shaped aperture surface. The expression “substantially closed” in this context means that in particular production-related gaps between the respective mutually contacting aperture elements are negligibly small. The closed ring-shaped aperture surface is arranged radially in the charge air inlet, so that charge air can flow through the flow orifice centrally through the charge air inlet. Advantageously the flow orifice of the closed ring-shaped aperture surface may be circular and approximately circular in the respective closed positions. In order to realise the circular and approximately circular flow orifice, the number of aperture elements in the adjustment device may for example be between 5 and 15. In principle, however, the number of aperture elements may be a random number. Alternatively or additionally the shape of the aperture elements in the adjustment device may be adapted as appropriate. Due to the essentially circular flow orifice turbulences in the airflow can be advantageously reduced.

Advantageously provision may be made for both sides of the respective aperture element to be in contact with respectively one side surface of the adjacent aperture element, so that the aperture elements in the respective closed position form the essentially closed ring-shaped aperture surface. The respective aperture element, in the aperture plane, has a circumferential contour, which in the aperture plane extends laterally along the respective aperture element in one circumferential direction and in doing so frames the respective aperture element. The above mentioned side surfaces of the respective aperture element are formed by portions of this circumferential contour. The side surfaces may for example be flat transversely to the circumferential direction and aligned in axial direction, i.e. extend at right angles to the aperture plane. Alternatively the side surfaces may be arched transversely to the circumferential direction or inclined to the axial direction. In order to allow the aperture elements to be moved together into the respective closed position when adjusting the adjustment device, the respective two side surfaces of the respective aperture element may be adjacent to each other and in particular merge into each other at a radially internal end of the respective aperture element. Further the respective two side surfaces, in particular at the said internal end, may be joining each other at a connecting angle of less than 90°. Advantageously the respective side surfaces of adjacent aperture elements movably contacting each other may be linear, at least in sections, in the circumferential direction/in the aperture plane or may comprise an identical radius of curvature. As a result it is possible for the respective side surfaces in particular, to slide off each other and to adapt the circular flow orifice with the aperture surface remaining closed.

With one advantageous further development of the adjustment device provision is made for the guidance arrangement to comprise a support ring and an adjusting ring, which are arranged radially in the charge air inlet and so as to be able to rotate relative to each other, wherein when the support ring and/or the adjusting ring are rotated relative to each other, the aperture elements can be moved into the respective closed positions. As such the support ring for example may be fixed in the charge air inlet in a material-bonded, force-fitted or form fitted manner and the adjusting ring on the support ring may be rotatable relative to the air inlet and thus relative to the support ring by means of an actuator arrangement. Alternatively the support ring may be integrally formed in the charge air inlet. Advantageously the aperture elements can then be arranged between the support ring and the adjusting ring and may be movably mounted thereon. The aperture elements for example may be axially in full-surface contact with the support ring and on the adjusting ring.

In order to move the aperture elements by means of the guidance elements it may be advantageously provided that the respective aperture element comprises an adjusting pin on a first closing surface in the aperture plane/on a closing surface extending in parallel thereto, and a support pin on a closing surface opposite the first closing surface. The two closing surfaces form the two axial sides of the respective aperture element. Due to the circumferential contour comprising the above-mentioned side surfaces, the two closing surfaces may enclose and form the respective aperture element. The support pin may then be movably arranged in a support long groove and the adjusting pin may be movably arranged in an adjusting long groove of the adjusting ring. Alternatively the respective aperture element may comprise an adjusting long groove on a first closing surface lying in the aperture plane, and a support long groove on a closing surface lying opposite the first closing surface. Similarly a support pin of the support ring may then be movably arranged in the support long groove, and an adjusting pin of the adjusting ring may then be movably arranged in the adjusting long groove. The respective aperture element is then in contact with the adjusting ring by means of the first closing surface and in contact with the second closing surface by means of the support ring. When the support ring and the adjusting ring are rotated relative to one another, the respective support pin can be guided in the respective support long groove and the respective adjusting pin can be guided in the respective adjusting long groove, as a result of which the aperture elements in the aperture plane are pushed into each other and moved into the respective closed position. Advantageously the respective aperture elements are steplessly movable between the support ring and the adjusting ring which means that a practically infinite number of closed positions in the adjustment device are achievable. With this arrangement the aperture elements in the respective closed positions are supported against each other in circumferential direction, thereby preventing turbulences in the airflow and therefore also vibrations and sound emissions in the compressor.

Advantageously, as a result of rotating the adjusting ring and/or the support ring relative to each other, the aperture elements may be movable tangentially relative to the adjusting ring and/or the support ring. The support long groove and the adjusting long groove may then be aligned in circumferential direction, so that the aperture elements can be tangentially guided in these. Advantageously the support long groove and/or the adjusting long groove may each comprise a guidance angle relative to the circumferential direction of the guidance arrangement. Alternatively or additionally the support long groove and/or the adjusting long groove may be shaped as a straight line or as an arch. Independently of how they are shaped, the support long groove is adapted to the support pin and the adjusting long groove is adapted to the adjusting pin such that the support pin is prevented from getting stuck in the support long groove and the adjusting pin is prevented from getting stuck in the adjusting long groove.

### SUMMARY

To summarise, in the compressor according to the invention the aperture elements are arranged in a common radial aperture plane and further are supported against each other in circumferential direction in the respective closed positions. This allows the ring-shaped closed aperture surface with the flow orifice to the formed, through which the charge air can flow. In the compressor according to the invention turbulences in the airflow and thus vibrations and sound emissions can therefore be avoided.

The invention also relates to an exhaust gas turbocharger with a turbine and with a compressor constructed as described above. The turbine and compressor are drivingly coupled so that when the turbocharger is operating, the turbine drives the compressor.

Further important features and advantages of the invention are revealed in the sub-claims, the drawings and the associated description of the figures with reference to the drawings.

It is understood that the above mentioned features and the features still to be explained can be utilised not only in the respectively stated combination but also in other combinations or on their own without leaving the scope of the present invention.

Preferred exemplary embodiments of the invention are depicted in the drawings and will be explained in detail in the description hereunder, wherein identical reference symbols refer to identical or similar or functionally identical components.

### BRIEF DESCRIPTION OF THE DRAWINGS

In the schematically drawn figures

FIG. 1 shows a partially sectional view of a compressor according to the invention with a compressor wheel and an adjustment device;

FIG. 2 shows a sectional view of the compressor depicted in FIG. 1;

FIG. 3 show views of an aperture element in a first embodiment in the adjustment device shown in FIG. 1;

FIG. 4 show views of an aperture element in a first embodiment in the adjustment device shown in FIG. 1;

FIG. 5 show views of an aperture element in a second embodiment in the adjustment device shown in FIG. 1;

FIG. 6 show views of an aperture element in a second embodiment in the adjustment device shown in FIG. 1;

FIG. 7 shows a view of a support ring in the adjustment device shown in FIG. 1;

FIG. 8 show views of a differently constructed adjusting ring in the adjustment device shown in FIG. 1;

FIG. 9 show views of a differently constructed adjusting ring in the adjustment device shown in FIG. 1;

FIG. 10 shows a view of the adjustment device shown in FIG. 1 in a minimally closed position;

FIG. 11 shows a view of the adjustment device shown in FIG. 1 in a maximally closed position.

### DETAILED DESCRIPTION

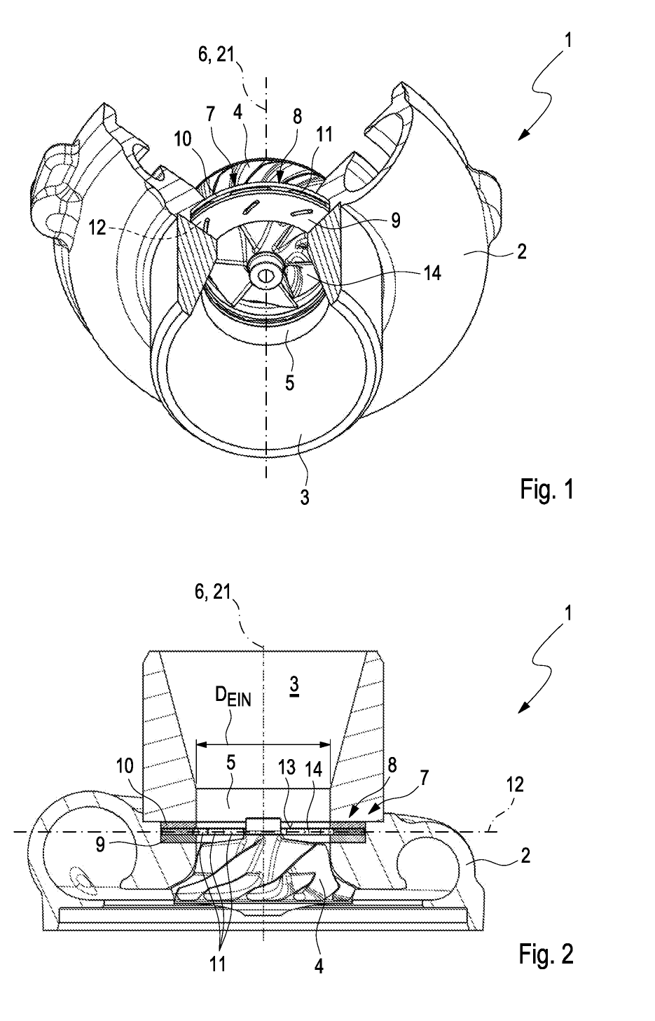

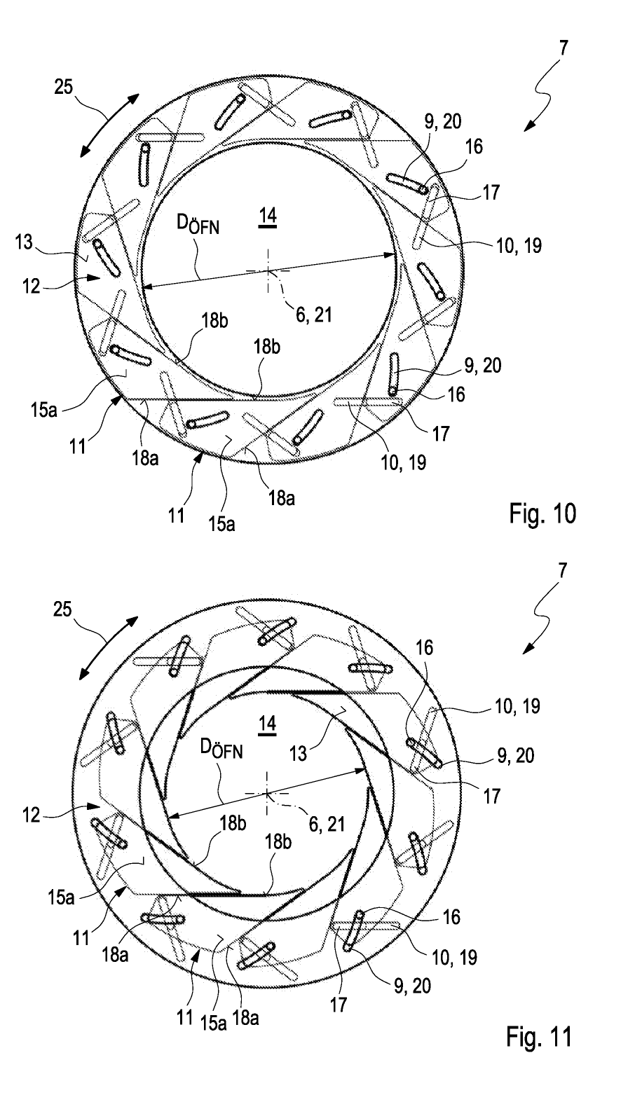

FIG. 1 shows a partly sectional view and FIG. 2 shows a sectional view of a compressor 1 according to the invention. The compressor 1 comprises a compressor housing 2 with an inlet channel 3 and with a compressor wheel 4. The inlet channel 3 leads to a charge air inlet 5, which is arranged in front of the compressor wheel 4 and through which charge air can flow in axial direction 6. In the present context this axial direction 6 is defined by an axis of rotation 21, about which the compressor wheel 4 is rotatably arranged in the compressor housing 2. The axial direction 6 extends in parallel to the axis of rotation 21. The radial direction generally extends at right angles to the axial direction 6, i.e. lies in a plane perpendicular to the axial direction 6. Specifically the radial direction extends perpendicularly to the axis of rotation 21. The circumferential direction 25 extends around the axis of rotation 21 and is indicated as a double arrow in FIG. 10 and FIG. 11. An adjustment device 7 for adapting a diameter D_{EIN} of the charge air inlet 5 is fixedly arranged in the charge air inlet 5. The adjustment device 7 comprises a ring-shaped radially arranged guidance arrangement 8 with an adjusting ring 9 and a support ring 10. The support ring 10 is fixed to the charge air inlet 5 and the adjusting ring 9 is rotatably mounted on the support ring 10.

A number of identical aperture elements 11 are arranged between the adjusting ring 9 and the support ring 10, the aperture elements 11 being movably mounted in the guidance arrangement 8. By rotating the adjusting ring 9 relative to the support ring 10 the guidance arrangement 8 can adjust the aperture elements 11 to assume an infinite number of closed positions, wherein the diameter D_{EIN} of the charge air inlet 5 is different in the respective closed positions. The infinite number of closed positions occurs between a maximally closed position and a minimally closed position, wherein the diameter D_{EIN} of the charge air inlet is at its minimum in the maximally closed position and at its maximum in the minimally closed position. In FIG. 1 and in FIG. 2 the aperture elements 11 have been moved into the minimally closed position, so that the charge air inlet 5 has the maximal diameter D_{EIN}.

According to the invention the aperture elements 11 are arranged in a common radial aperture plane 12, which extends perpendicularly to the axial direction 6, and they are supported against each other in the respective closed positions in the circumferential direction 25. Viewed radially the aperture elements 11 form a closed ring-shaped aperture plane 13 with an approximately circular flow orifice 14 for the charge air to flow through it in axial direction 6. The flow orifice 14 is arranged flush with the charge air inlet 5, so that in the minimally closed position—as shown in FIG. 1 and FIG. 2—a diameter D_{ÖFN} of the flow orifice 14 corresponds to the diameter D_{EIN} of the charge air inlet 5. When the aperture elements 11 are moved by the guidance arrangement 8 out of the minimal closed position shown in FIG. 1 and FIG. 2, the diameter D_{öFN} of the flow orifice 14 is reduced thereby partially closing the charge air inlet 5 and reducing the diameter D_{EIN} of the charge air inlet 5.

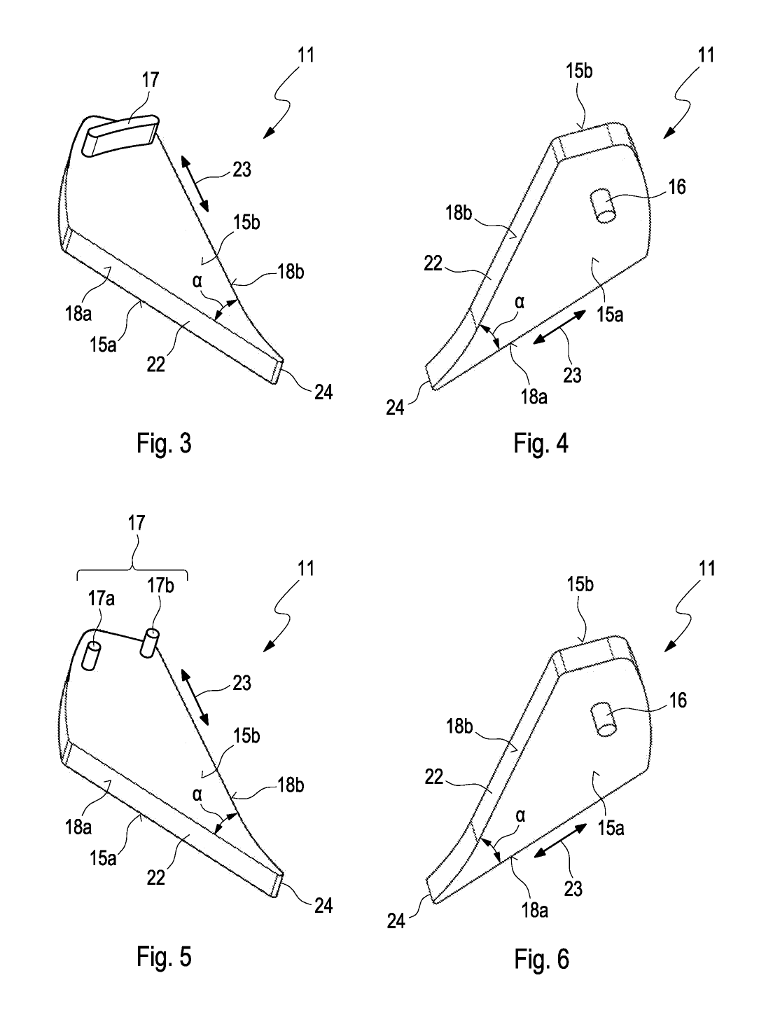

Further details for constructing the adjustment device 7 are explained in detail hereunder with reference to FIGS. 3 to 11.

FIG. 3 and FIG. 4 show views of the individual aperture element 11 in a first embodiment. The aperture element 11 comprises an adjusting pin 16 on a first closing surface 15a and an elongated support pin 17 on a closing surface 15b lying opposite the first closing surface 15a. The adjusting pin 16 cooperates with the adjusting ring 9 and the support pin 17 cooperates with the support ring 10. The aperture surface 13 of the adjustment device 7 is formed by the respective closing surfaces 15a, which are radially aligned in the adjustment device 7. The aperture element 11 further comprises two neighbouring side surfaces 18a and 18b, which join each other at a connecting angle α of less than 90°. The aperture element 11 has an approximately triangular shape. With its side surfaces 18a and 18b the aperture element 11 is supported against the neighbouring aperture elements 11 of the adjustment device 7.

In detail, in the aperture plane 12 the respective aperture element 11 comprises a circumferential contour 22, which extends in the aperture plane 12 laterally along the respective aperture element 11 in a circumferential direction 23 indicated by a double arrow in FIGS. 3 to 6, thereby framing the respective aperture element 11. The above-mentioned side surfaces 18a and 18b of the respective aperture element 11 are formed by portions of this circumferential contour 22, which are facing away from each other. In the examples shown the side surfaces 18a and 18b are flat or planar transversely to the circumferential direction 23 and aligned in axial direction 6 such that they extend at right angles to the aperture plane 12. The respective aperture element 11 comprises, spaced apart from the adjusting pin 16/the support pin 17, a radially internal end 24 when fitted. The circumferential contour 22 tapers to a point at the internal end 24. At the internal end 24 the side surfaces 18a and 18b merge into each other.

FIG. 5 and FIG. 6 show views of the aperture element 11 in a second embodiment. Differently from the aperture element 11 in FIG. 3 and FIG. 4, here the support pin 17 of the aperture element 11 is formed by two individual pins 17a and 17b. In other respects the aperture element 11 here corresponds to the aperture element 11 shown in FIG. 3 and FIG. 4. The aperture elements 11 in the first and second embodiments are mutually replaceable in the adjustment device 7 without the remaining elements of the adjustment device 7 having to be adapted.

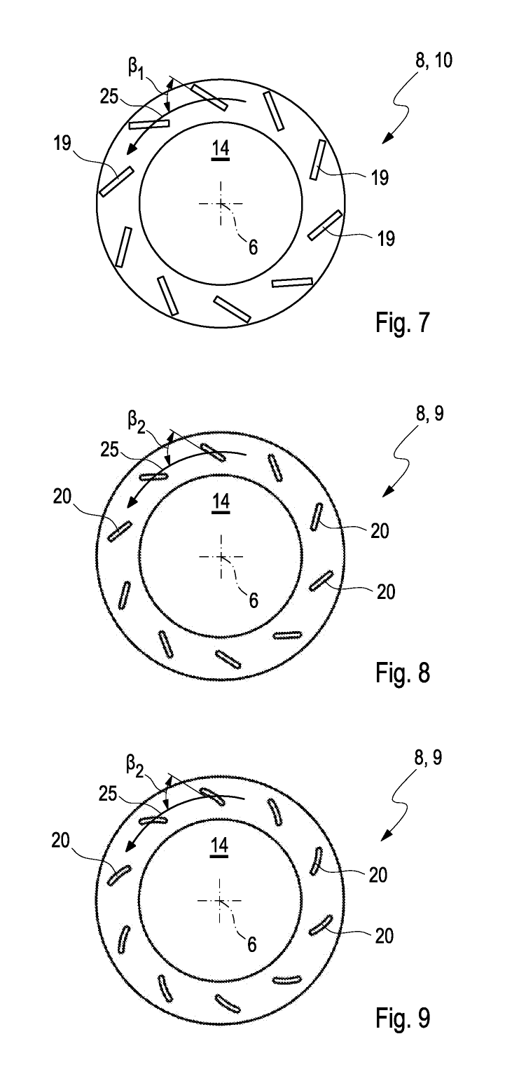

FIG. 7 shows a view of the support ring 10 of the guidance arrangement 8 in the adjustment device 7. The support ring 10 comprises a support long groove 19 for each of the aperture elements 11. The support long groove 19 is shaped linearly and aligned at a guidance angle β₁ to the circumferential direction 25 of the support ring 10. The respective support pin 17 of an aperture element 11 is movably arranged in the respective support long groove 19, so that the support ring 10 can cooperate with the respective aperture elements 11.

FIG. 8 shows a view of the adjusting ring 9 in a first embodiment. The adjusting ring 9 comprises an adjusting long groove 20 for each of the aperture elements 11. The adjusting long groove 20 is shaped linearly and is aligned at a guidance angle β₂ to the circumferential direction 25 of the adjusting ring 9. The corresponding adjusting pin 16 of one of the aperture elements 11 is movably arranged in the corresponding adjusting long groove 20, so that the adjusting ring 9 can cooperate with the respective aperture elements 11.

In FIG. 9 a view of the adjusting ring 9 is shown in a second embodiment. Differently from the adjusting ring 9 in FIG. 8 the respective adjusting long groove 20 is shaped as an arch. In other respects the adjusting ring 9 shown here corresponds to the adjusting ring shown in FIG. 8. The adjusting rings 9 in the first and in the second embodiment are mutually replaceable in the adjustment device 7 without the remaining elements of the adjustment device 7 having to be adapted.

FIG. 10 shows a view of the adjustment device 7 in the minimally closed position viewed from the adjusting-ring-side. FIG. 11 shows a view of the adjustment device 7 in the maximally closed position viewed from the adjusting-ring-side. The non-visible parts of the support ring 10 and the aperture elements 11 are indicated by thinner lines. In the adjustment device 7 the aperture elements 11 are in contact with each other with their side surfaces 18a and 18b in circumferential direction 25. The closing surfaces 15a of the respective aperture elements 11 form a closed ring-shaped aperture surface 13 with the flow orifice 14. The aperture elements 11 are movably mounted between the adjusting ring 9 and the support ring 10, wherein the adjusting pin 16 is movably arranged in the corresponding adjusting long groove 20 and the support pin 17 is movably arranged in the corresponding support long groove 19.

When rotating the adjusting ring 9 relative to the support ring 10 the aperture elements 11 cooperate with the adjusting ring 9 and the support ring 10. The adjusting pin 16 is guided along the corresponding adjusting long groove 20 and the support pin 17 is guided along the support long groove 19. The neighbouring aperture elements 11 slide off the side surfaces 18a and 18b which are in contact with each other, and the diameter D_{ÖFN} of the flow orifice 14—and correspondingly the diameter D_{EIN} of the charge air inlet 5—increases or decreases according to the direction of rotation of the adjusting ring 9 on the support ring 10. This enables an infinite number of closed positions to be set between the minimally closed position—as shown in FIG. 10—and the maximally closed position—as shown in FIG. 11.

Independently of the setting of the closed position the aperture elements 11 of the adjustment device 7 are in contact with each other with their side surfaces 18a and 18b in circumferential direction 25. The aperture surface 13 is closed and the flow orifice 14 is approximately circular. Advantageously this has the effect of preventing turbulences in the airflow and thus undesirable vibrations and sound emissions in the compressor 1.

1. A compressor for compressing charge air for a combustion engine, wherein the compressor comprises:
a charge air inlet, through which charge air can flow in an axial direction and in which an adjustment device is fixedly arranged for adapting a diameter of the charge air inlet,
wherein the adjustment device comprises a ring-shaped radially arranged guidance arrangement and aperture elements movably mounted in the guidance arrangement,
wherein the aperture elements are adjustable by the guidance arrangement in at least two closed positions and perpendicularly to the axial direction, wherein the diameter of the charge air inlet is different in the respective at least two closed positions, and
wherein the aperture elements are arranged in a common radial aperture plane and are tightly fitted against each other in a circumferential direction in the respective at least two closed positions.

2. The compressor according to claim 1, wherein the aperture elements, in the respective at least two closed positions, radially form a closed ring-shaped aperture surface with a flow orifice for the through-flow of the charge air.

3. The compressor according to claim 1, wherein the flow orifice of the closed ring-shaped aperture surface is circular or approximately circular in the respective at least two closed positions.

4. The compressor according to claim 1, the wherein a respective one of the aperture elements includes side surfaces and is movably supported against a respective side surface of a neighboring one of the aperture elements, and the aperture elements form the closed ring-shaped aperture surface in the respective closed position.

5. The compressor according to claim 4, the side surfaces of the respective one of the aperture elements are adjacent to each other and adjoin each other at a connecting angle of less than 90°.

6. The compressor according to claim 1, wherein the aperture elements include neighboring aperture elements with adjoining side surfaces that are movable relative to each other, and at least two sections of the adjoining side surfaces of the neighboring aperture elements are linearly shaped or comprise an identical radius of curvature.

7. The compressor according to claim 1, the guidance arrangement comprises a support ring and an adjusting ring, which are arranged radially in the charge air inlet and rotatably to each other, wherein when the support ring or the adjusting ring are rotated relative to each other, the aperture elements can be moved into the respective at least two closed positions.

8. The compressor according to claim 7, wherein the aperture elements are arranged between the support ring and the adjusting ring and movably mounted thereon.

9. The compressor according to claim 8, that wherein at least one of the respective aperture elements comprises an adjusting pin on a first closing surface lying in the common radial aperture plane and a support pin on a closing surface opposite the first closing surface, and
wherein the support pin is movably arranged in a support long groove of the support ring and the adjusting pin is movably arranged in an adjusting long groove of the adjusting ring.

10. The compressor according to claim 8, wherein at least one of the respective aperture elements comprises an adjusting long groove in a first closing surface lying in the aperture plane and a support long groove in a closing surface lying opposite the first closing surface, and wherein a support pin of the support ring is movably arranged in the support long groove and an adjusting pin of the adjusting ring is movably arranged in the adjusting long groove.

11. The compressor according to claim 9, wherein at least one of:
the support long groove or the adjusting long groove comprises a guidance angle relative to the circumferential direction of the guidance arrangement, and
the support long groove or the adjusting long groove is shaped as a straight line or as an arch.

12. The compressor according to claim 7, wherein, in response to rotating the support ring and/or the adjusting ring relative to each other, the aperture elements are tangentially movable relative to the support ring or the adjusting ring.

13. The compressor according to claim 7, wherein the support ring is fixed in the charge air inlet in a material-bonded, force-fitted or form fitted manner or is integrally formed therein.

14. The compressor according to claim 1, wherein the compressor is part of a turbocharger with a turbine.

15. A system for compressing charge air for a combustion engine, comprising:
a charge air inlet configured to flow charge air in an axial direction;
an adjustment device adapted to be fixedly arranged to the charge air inlet, wherein the adjustment device comprises a guidance that is ring-shaped and radially arranged and aperture elements movably mounted in the guidance arrangement,
wherein the aperture elements are adjustable by the guidance arrangement in at least two closed positions and perpendicularly to the axial direction, wherein the diameter of the charge air inlet is different in the respective at least two closed positions, and
wherein the aperture elements are configured to be arranged in a common radial aperture plane and against each other in a circumferential direction in the respective at least two closed positions.

16. The compressor according to claim 15, wherein the aperture elements, in the respective at least two closed positions, radially form a closed ring-shaped aperture surface with a flow orifice for the through-flow of the charge air.

17. The compressor according to claim 15, wherein the flow orifice of the closed ring-shaped aperture surface is circular or approximately circular in the respective at least two closed positions.

18. The compressor according to claim 15, wherein a respective one of the aperture elements includes side surfaces and is movably supported against a respective side surface of a neighboring one of the aperture elements, and the aperture elements form the closed ring-shaped aperture surface in the respective closed position.

19. The compressor according to claim 18, the side surfaces of the respective one of the aperture elements are adjacent to each other and adjoin each other at a connecting angle of less than 90°.

20. The compressor according to claim 15, wherein the aperture elements include neighboring aperture elements with adjoining side surfaces that are movable relative to each other, and at least two sections of the adjoining side surfaces of the neighboring aperture elements are linearly shaped or comprise an identical radius of curvature.
